(19) United States
(12) Patent Application Publication
(10) Pub. No.: US 2005/0161623 A1
(43) Pub. Date: Jul. 28, 2005

(54) Apparatus for measuring photoluminescing species such as those found in liquid chromatography and capillary electrophoresis and process for making same

(76) Inventors: David Reginold Carver, Colorado Springs, CO (US); Daniel Patrick Brennan, Colorado Springs, CO (US)

Correspondence Address: David R. Carver, 4365 Reginold Ct., Colorado Springs, CO, 80906, US

(21) Appl. No.: 10/764,549

(22) Filed: Jan. 27, 2004

(51) Int. Cl. G01N 21/49

(52) U.S. Cl. 250/576

(57) ABSTRACT

The present invention generally relates to the determination of photoluminescence of samples. More specifically, the present invention is directed to a method particularly adapted to samples which are flowing liquids. The method and apparatus are useful for measuring photoluminescing species such as those found in liquid chromatography and capillary electrophoresis.

An apparatus for measuring photoluminescing species such as those found in liquid chromatography and capillary electrophoresis and process for making same.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of photoluminescence detection and measurement and more specifically to an apparatus for measuring photoluminescing species such as those found in liquid chromatography and capillary electrophoresis and process for making same.

Photoluminescence of samples is divided into two major divisions. One technique is florescence and the other is phosphorescence. Fluorescence differs from phosphorescence in that the emitted light responsible for the photoluminescence is short lived in the case of florescence and in phosphorescent emissions it is much longer-lived and easily detectable a measurable time period after excitation.

Fluorescent species particularly those of organic structure are interesting both in the compounds themselves and useful as tags for the labeling of other molecular species which do not exhibit photoluminescence. Application of this method is particularly suited for compounds, which are not available in large quantities such as nucleic acid, protein sequencing and trace contaminant detection.

Instruments are currently available to determine the qualitative and quantitative measurement of photoluminescence. Their utility in the field of molecular biology are well known and of high value. In most applications the determination of photoluminescence is achieved through the determination of fluorescing species. Thus the general term photoluminescence has been applied to instruments which are known as fluorescence meters or fluorometers.

Application of the fluorescence technique in a flowing liquid, such as that found in HPLC is well known. The main advantage of fluorescence detection over simple absorbance detection is the increased sensitivity the fluorescence technique provides versus that of absorption. In many cases, the detection sensitivity of the fluorescence method is the limiting factor in making a determination of the samples attributes. Due to this reason, high value samples of very limited quantity such as in DNA sequencing cannot be performed as easily as the analyst desires. For this reason there is a need for a more sensitive fluorometer or more generally a photoluminescence apparatus.

### BRIEF SUMMARY OF THE INVENTION

It is an object of the present invention to provide a new and useful apparatus for measuring photoluminescence.

According to the present invention, a method for detecting and measuring photoluminescence is provided. A unique optical arrangement is disclosed which provides the greater sensitivity necessary for this technique to have improved sensitivity. The method is comprised of the following elements:

a) excitation light source

b) Sample holding optical cell with integral light pipes. The term light pipe as used in this patent is defined as any dielectric media or dielectric waveguide, such that the cross-sectional distance of the light entrance into the light pipe is less than two hundred percent the length of the light pipe.

c) Emission photosensor

An excitation light source is chosen such that the sample to be illuminated absorbs some of the light that is produced by the source. The light is introduced into the sample via the means of a sample holding optical cell with integral light pipes. The cell may consist of any material and take any form. The light pipes may be a short rod of glass, a fiber optic light pipe, or any dielectric media. The sample is introduced directly on the end of the light pipe. This provides the advantage of strong illumination of the sample without having the diffusive effects of the sample being further from the light source. In addition, the introduction of the sample at the end of a well defined light source decreases the chances of cross talk of the excitation source with the light emitted by the sample.

The sample emits light upon excitation and this light is immediately introduced into another light pipe. This close proximity of the light pipe to the excited sample provides a higher solid angle of light acceptance. The output of the emission light pipe can be coupled to a photosensor directly or by imaging the output through a lens onto the photosensor. Due to the defined optical characteristics of the light pipe in close proximity of the sample the crosstalk b tween the excitation light source and the mission light source of the sample are minimized.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a method according to claim 1, where the light source for excitation is in the wavelength range from 195 nm to 1050 nm.

In accordance with a preferred embodiment of the invention, there is disclosed a method according to claim 1, wherein the light pipes of the sample holder with integral light pipes are comprised of fiber optic material.

In accordance with a preferred embodiment of the invention, there is disclosed a method according to claim 3, wherein the cross-sectional distance of the light entrance of the integral light pipe is in the range from 25 micrometers to 3 mm diameter.

In accordance with a preferred embodiment of the invention, there is disclosed. a method according to claim 1, wherein a lens focuses the light source onto the excitation light pipe.

In accordance with a preferred embodiment of the invention, there is disclosed a method according to claim 1, wherein a lens focuses the light emitted from the emission light pipe onto a photosensor.

In accordance with a preferred embodiment of the invention, there is disclosed a method according to claim 1, wherein the sample being examined is a solid sample.

In accordance with a preferred embodiment of the invention, there is disclosed a method according to claim 1 wherein the sample being examined is in a gaseous state.

In accordance with a preferred embodiment of the invention, there is disclosed a method according to claim 1, wherein the sample being examined is in a liquid state.

In accordance with a preferred embodiment of the invention, there is disclosed A method according to claim 1, wherein the integral light pipes are 100 microns to 100 meters in length.

In accordance with a preferred embodiment of the invention, there is disclosed A method according to claim 1, wherein the body of the sample cell holder is comprised of a material which absorbs the wavelengths being used for either excitation or emission.

In accordance with a preferred embodiment of the invention, there is disclosed A method according to claim 1, wherein the light source is a light emitting diode.

In accordance with a preferred embodiment of the invention, there is disclosed a method according to claim 1, wherein an optical wavelength filter is between light source and sample holder.

In accordance with a preferred embodiment of the invention, there is disclosed a method according to claim 1, wherein an optical wavelength filter is between the emission light pipe and the photosensor.

In accordance with a preferred embodiment of the invention, there is disclosed. a method according to claim 1, wherein the output of the emission optical fiber is the input of a spectrometer.

In accordance with a preferred embodiment of the invention, there is disclosed a method according to claim 1, wherein the light source is a monochromator

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the optical arrangement of the apparatus according to the present invention.

FIG. 2 is an example of an alternative optical arrangement of the apparatus.

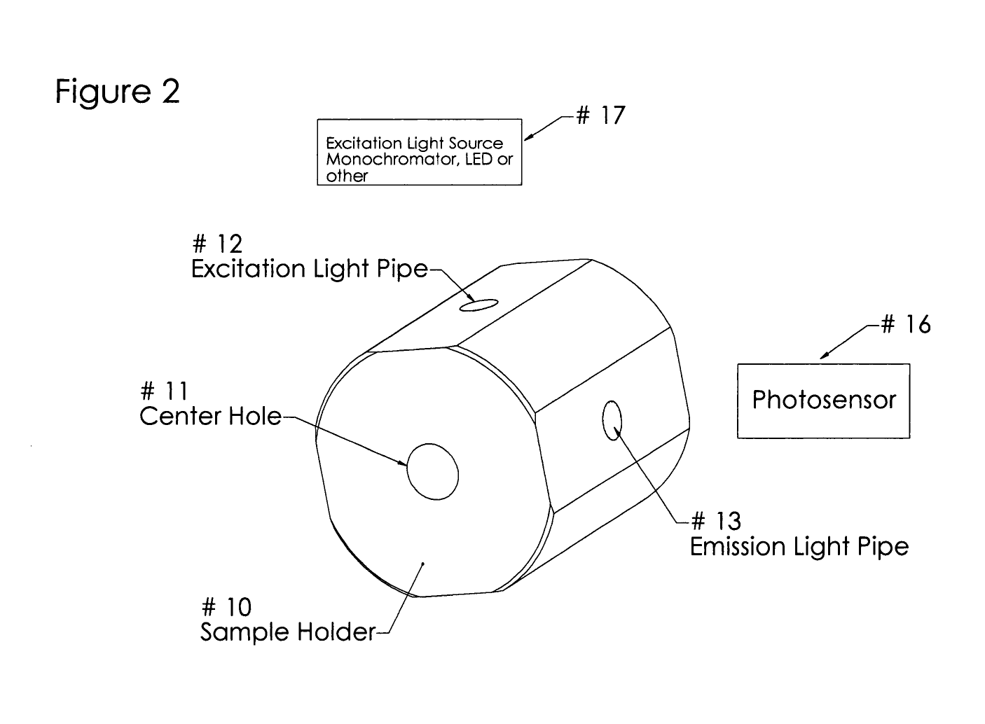

FIG. 3 is an example of an alternative optical arrangement of the apparatus.

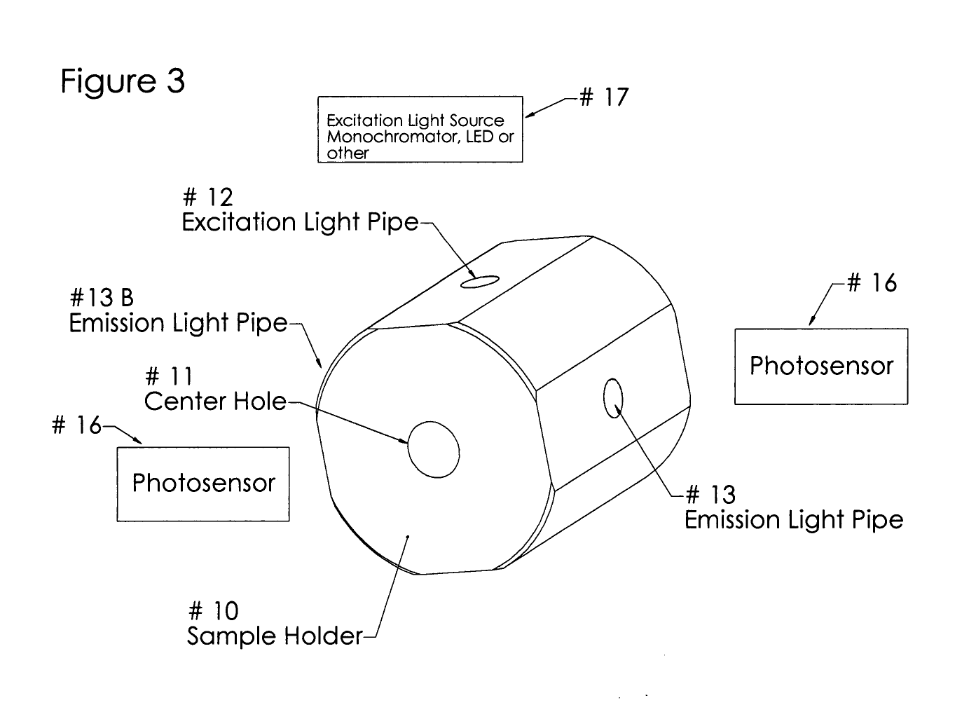

FIG. 4 is a perspective view of the sample holding optical cell with integral light pipes.

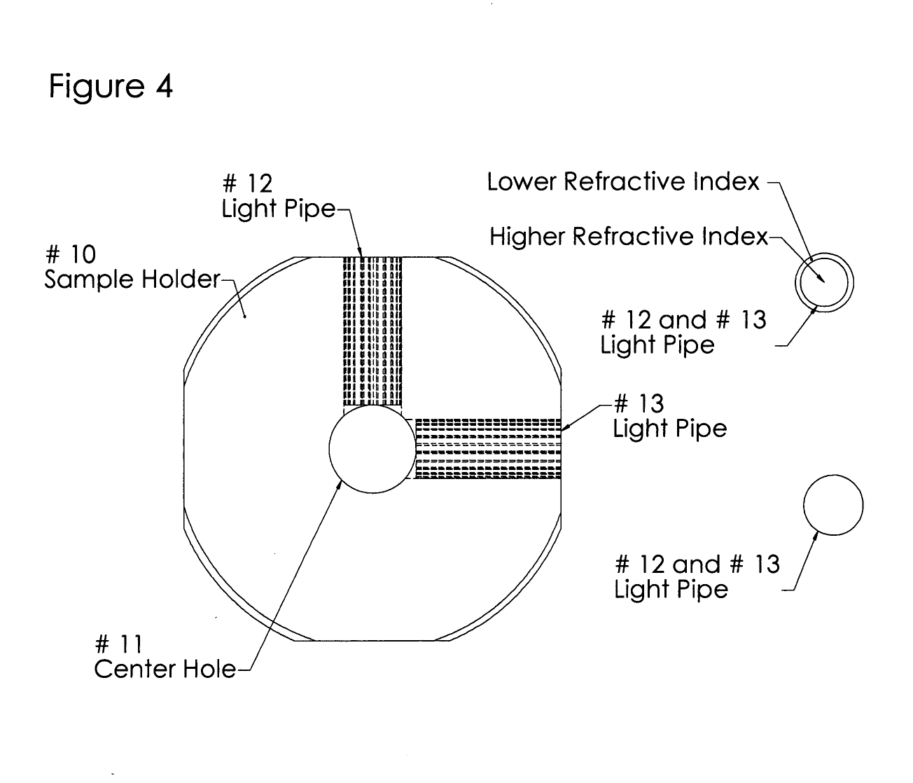

FIG. 5 is an example of an alternative sample holding optical cell with integral light pipes.

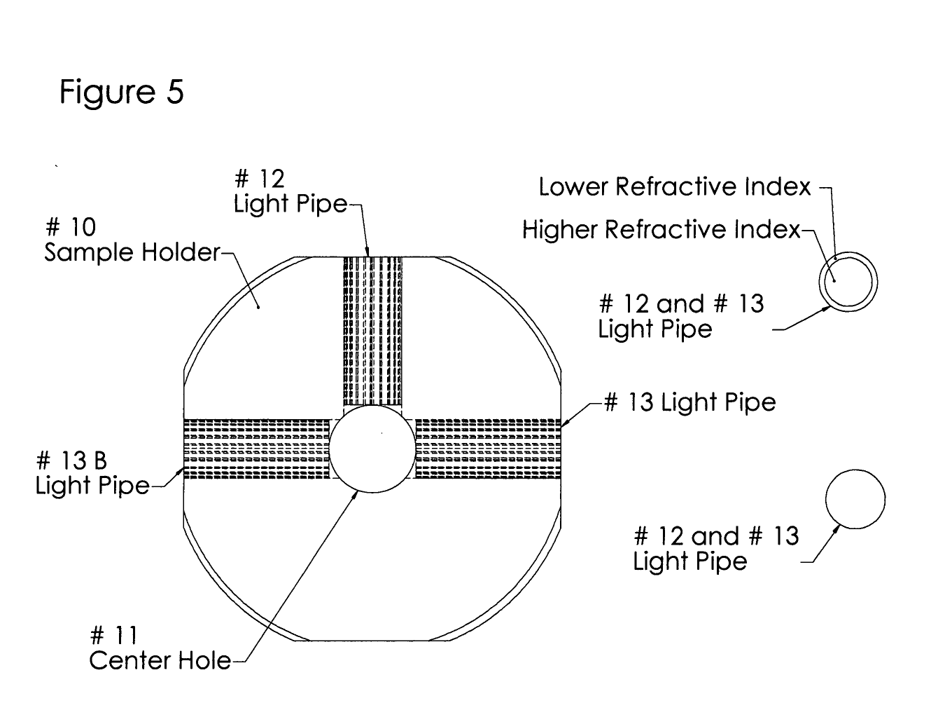

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention is directed to a method for determining photoluminescence of a sample. The method and apparatus of the present invention are particularly adapted for use with flowing liquid samples. The apparatus described has particular application in the field of liquid chromotography and capillary electrophoresis. As described above, the existing instrumentation for performing photoluminescence of a sample is based upon optically exciting the sample and imaging and collecting the resulting emission light onto a photosensor. We determined that utilizing the chemical inertness and the optical characteristics of integral light pipes into the sample holder dramatically improved the excitation of the sample, collection efficiency of the emitted light, and crosstalk between the two optical paths of emission and excitation.

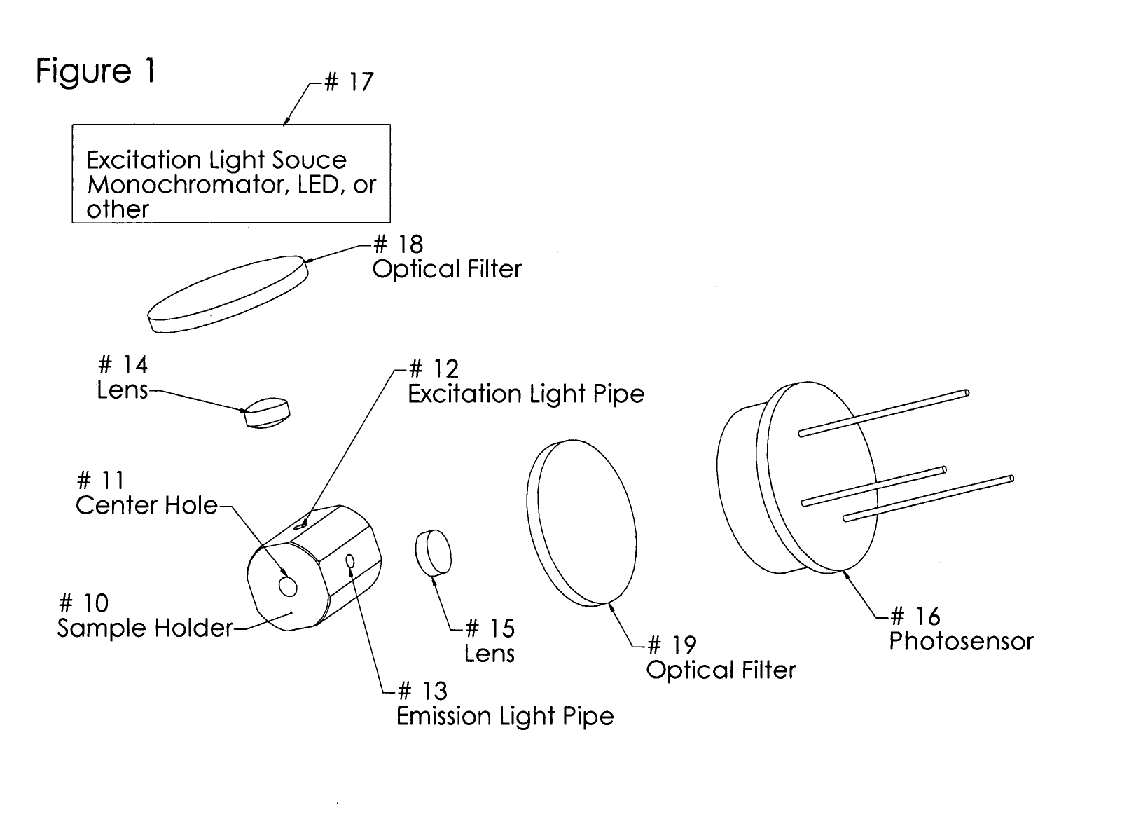

Accordingly, the present invention provides a unique method for determining photoluminescence of a sample either solid, liquid, or gas. In the example shown in FIG. 1, a preferred embodiment of the apparatus according to the present invention includes light source 17 which in the preferred embodiment is the output of a monochrometer such as shown in (U.S. Pat. No. 5,699,156). Output of such a monochrometer or other excitation light sources are commonly in the wavelength range from 180 nm to 1050 nm. Optionally if the light source is not a monochromatic source it is advantageous to introduce an optical element such as a band pass interference filter to reduce the light that could be scattered from excitation at the emission wavelength into the emission optical path. The output of that light is directed toward lens 14 (optional) which focuses the light onto the input of the excitation light pipe 12. Such light pipes are commonly fiber optic materials where the index of refraction of the circumference of the fiber is less than that in the center of the fiber. Other light pipes where the circumference of the light pipe is reflective serve in a similar manner as a fiber optic. Such optical light pipes are in the range of the diameters from 25 micrometers to 3 mm. Typical lengths for the light pipe range from 100 micrometers to 100 meters in length. The light pipes which simply transmits the impenging light may more clearly be termed a light pipe when the material around the circumference of the light pipe is comprised of a light absorbing material. The optical element, thereby becomes a light transmitting device which acts similar to a fiber optic or other light piping device, wherein the entrance of the light pipe serves as an aperture and the exit of the light pipe is a defined diameter exit for the light. The output of light pipe 12 goes into a center hole 11 in sample holder 10. Sample holder 10 is preferred to be made from a material which absorbs the excitation light. It is not necessary for all the benefits of this invention to be realized for the body to be made from a dark material, but decreased crosstalk from the excitation to the emission channels can be realized with a dark material. The sample is introduced through center hole 11 as a flowing stream of liquid sample or alternatively as a solid sample. The excitation light from light pipe 12 is absorbed by the sample in hole 11 and emits light which is introduced into light pipe 13. The output of light pipe 13 impinges on lens element 15 to be collected onto photosensor 16, such a photosensor is known to be a silicon diode or a photomultiplier tube. Alternatively lens element 15 can be eliminated if photosensor 16 can be introduced close enough to optical element 13 to collect its light without unreasonable losses. Optionally element 19, optical filter, can be introduced between the emission light pipe output and the photosensor. The emission light pipe can be passed through an optical filter to eliminate stray light which is outside the emission wavelength. The optical filter can be any number of filtering devices including but not limited to interference filters, optical glasses, and spectrometers.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method for detecting and measuring photoluminescence comprising:
a) Light source for excitation
b) Sample holder cell with integral light pipes.
c) Emission photosensor

2. A method according to claim 1, where the light source for excitation is in the wavelength range from 180 nm to 1050 nm.

3. A method according to claim 1, wherein the light pipes of the sample holder with integral light pipes are comprised of fiber optic material.

4. A method according to claim 3, wherein the cross-sectional distance of the light entrance of the integral light pipe is in the range from 25 micrometers to 3 mm diameter.

5. A method according to claim 1, wherein a lens focuses the light source onto the excitation light pipe.

6. A method according to claim 1, wherein a lens focuses the light emitted from the emission light pipe onto a photosensor.

7. A method according to claim 1, wherein the sample being examined is a solid sample.

8. A method according to claim 1 wherein the sample being examined is in a gaseous state.

9. A method according to claim 1, wherein the sample being examined is in a liquid state.

10. A method according to claim 1, wherein the integral light pipes are 100 micrometers to 100 meters in length.

11. A method according to claim 1, wherein the body of the sample cell holder is comprised of a material which absorbs the wavelengths being used for either excitation or emission.

12. A method according to claim 1, wherein the light source is a light emitting diode.

13. A method according to claim 1, wherein an optical wavelength filter is between light source and sample holder.

14. A method according to claim 1, wherein an optical wavelength filter is between the emission light pipe and the photosensor.

15. A method according to claim 1, wherein the output of the emission optical fiber is the input of a spectrometer.

16. A method according to claim 1, wherein the light source is a monochromator.

17. A method according to claim 1, wherein only one optical path is a light pipe.
